(19) United States
(12) Patent Application Publication
(10) Pub. No.: US 2026/0342583 A1
(43) Pub. Date: Oct. 29, 2026

(54) DATA SECURITY PROTECTION SYSTEM AND METHOD BASED ON ANTI-AI INFILTRATION TECHNOLOGY

(71) Applicant: ZHEJIANG HANNAO DIGITAL TECHNOLOGY CO., LTD., Jiaxing (CN)

(72) Inventor: Zhengwei GUO, Jiaxing (CN)

(21) Appl. No.: 19/656,142

(22) Filed: Apr. 23, 2026

Related U.S. Application Data
(63) Continuation of application No. PCT/CN2026/083731, filed on Mar. 16, 2026.

(30) Foreign Application Priority Data
Apr. 23, 2025 (CN) 202510512368.4

(51) Int. Cl. H04L 9/32; G06F 21/60

(52) U.S. Cl. CPC H04L 9/3231; G06F 21/602

(57) ABSTRACT

The present invention discloses a data security protection system and method based on anti-AI infiltration technology, comprising steps of: S1, receiving user identity data sent by a client; S2, generating a unique ePASS-ID by using a national cryptographic algorithm or other encryption algorithms; S3, parsing a digital appointment document according to a preset organizational structure information database, and generating permission data corresponding to the ePASS-ID; S4, receiving a registration request from an AI entity, acquiring model fingerprint data of the AI entity, and generating an AI identity identifier by using the national cryptographic algorithm or other encryption algorithms; S5, determining whether an anomaly exists based on a deep learning algorithm; and S6, processing service data.

### CROSS-REFERENCE TO RELATED APPLICATIONS

This application is a continuation of PCT/CN2026/083731, filed Mar. 16, 2026, and claims priority of Chinese Patent Application No. 202510512368.4, filed on Apr. 23, 2025, the entire contents of which are incorporated herein by reference.

### TECHNICAL FIELD

The present invention relates to the field of data security and network security, and in particular, to a data security protection system and method based on anti-AI infiltration technology.

### BACKGROUND

In the prior art, data security protection systems typically protect data resources by means of access control lists (ACLs), firewall rules, and static identity authentication mechanisms. For example, role-based access control (RBAC) technology restricts data access through predefined user permissions, combined with symmetric encryption algorithms (e.g., AES) or asymmetric encryption algorithms (e.g., RSA) to protect data in transmission and storage. In addition, some systems adopt log recording and rule matching methods to monitor abnormal behaviors, for example, detecting potential malicious access by setting an API call frequency threshold. These technologies have been widely applied in traditional network security scenarios and have achieved, to a certain extent, protection against known threats.

In the prior art, attack methods in which an AI entity forges an identity include, but are not limited to, simulating user behaviors through generative adversarial networks (GANs), forging biometric data, or probing system vulnerabilities through high-frequency API calls. These attacks usually occur in unregistered or anonymous access scenarios, and existing systems lack the capability for pre-verification of an AI entity identity and extraction of behavioral features. For example, traditional systems have difficulty distinguishing between a legitimate AI (e.g., an intelligent customer service deployed by an enterprise) and a malicious AI (e.g., an automated script of an external attacker), resulting in insufficient targeting of protection measures.

### SUMMARY

To remedy the above deficiencies, the present invention provides a data security protection system and method based on anti-AI infiltration technology, aiming to improve the problem in traditional systems of difficulty in distinguishing between a legitimate AI (e.g., an intelligent customer service deployed by an enterprise) and a malicious AI (e.g., an automated script of an external attacker).

In a first aspect, the present invention provides the following technical solution: a data security protection method based on anti-AI infiltration technology, applied to a server and comprising steps of:
S1, receiving user identity data sent by a client, wherein the user identity data comprises biometric data and behavioral data;
S2, generating a unique ePASS-ID based on the user identity data by using a national cryptographic algorithm or other encryption algorithms, and encrypting and storing the biometric data by using the national cryptographic algorithm or other encryption algorithms;
S3, parsing a digital appointment document according to a preset organizational structure information database, and generating permission data corresponding to the ePASS-ID, wherein the permission data is dynamically allocated based on a four-dimensional permission control model;
S4, receiving a registration request from an AI entity, performing pre-verification on an identity of the AI entity, acquiring model fingerprint data of the AI entity after the pre-verification is passed, generating an AI identity identifier by using the national cryptographic algorithm or other encryption algorithms, and restricting an access scope of the AI entity according to AI behavior whitelist rules;
S5, monitoring, in real-time, an API call behavior of the AI entity, determining whether an anomaly exists based on a deep learning algorithm, and blocking access of the AI entity and triggering an alarm in a case that an anomaly exists; and
S6, processing service data, performing encrypted transmission by using the national cryptographic algorithm or other encryption algorithms, performing encrypted storage by using the national cryptographic algorithm or other encryption algorithms, and verifying data integrity by using the national cryptographic algorithm or other encryption algorithms.

Preferably, the biometric data in step S1 comprises face data, iris data, voiceprint data, and finger vein data; the behavioral data comprises user operation habit data; and the user identity data is verified by a multimodal credential system.

Preferably, the four-dimensional permission control model in step S3 comprises: an organizational structure dimension, for generating a permission inheritance relationship according to an enterprise hierarchical structure;
a data sensitivity dimension, for performing hierarchical encryption on data based on the national cryptographic algorithm or other encryption algorithms;
a business scenario dimension, for isolating different business environments with encrypted sandboxes created by the national cryptographic algorithm or other encryption algorithms; and
a time-space dimension, for restricting access permissions based on GPS and IP addresses.

Preferably, the AI behavior whitelist rules in step S4 comprise:
registering the model fingerprint data of the AI entity, and limiting a data interaction scope of the AI entity; and
prohibiting the AI entity from accessing sensitive data exceeding a permission corresponding to the ePASS-ID of the AI entity.

Preferably, the monitoring in real-time in step S5 comprises:
isolating an operation of the AI entity in an AI behavior sandbox; and
triggering a secondary biometric verification in a case that an abnormal API call is detected.

Preferably, step S6 further comprises:
adding a hash digital watermark generated by the national cryptographic algorithm or other encryption algorithms to exported data; and
setting up a multi-level approval process for sensitive data operations and storing the approval process on a blockchain for evidence preservation.

In a second aspect, the present invention provides the following technical solution: a data security protection system based on anti-AI infiltration technology, configured on a server and comprising:
a receiving module, configured to receive user identity data sent by a client and a registration request from an AI entity;
an identity generation module, configured to generate an ePASS-ID based on the user identity data, and generate an identity identifier for the AI entity;
a permission allocation module, configured to generate and allocate permission data according to an organizational structure information database;
a monitoring module, configured to monitor, in real-time, an API call behavior of the AI entity and determine an anomaly; and
a data processing module, configured to perform encrypted transmission and storage on service data.

Preferably, the identity generation module is configured to generate the ePASS-ID by using the national cryptographic algorithm or other encryption algorithms, and encrypt the biometric data by using the national cryptographic algorithm or other encryption algorithms.

In a third aspect, the present invention provides the following technical solution: a computer device, comprising a memory, a processor, and a computer program stored in the memory and executable on the processor, wherein the processor, when executing the computer program, is configured to implement the above data security protection method based on anti-AI infiltration technology.

In a fourth aspect, the present invention provides the following technical solution: a readable storage medium, wherein a computer program is stored on the readable storage medium, and when executed by a processor, the computer program is configured to implement the above data security protection method based on anti-AI infiltration technology.

The present invention has the following beneficial effects:
1. In the present invention, by introducing an identity pre-verification mechanism during AI entity registration, AI behavior whitelist rules, and a real-time monitoring mechanism, it is possible to effectively identify and block forged identities and abnormal API call behaviors of an AI entity (e.g., a malicious generative model). A traceable identity identifier is assigned to a legitimate AI through digital signature and behavior log verification, and model fingerprint data is generated in combination with behavioral feature extraction, thereby overcoming the limitation in the prior art of difficulty in distinguishing between legitimate and malicious AI.
2. In the present invention, the proposed four-dimensional permission control model (organizational structure, business scenario, data sensitivity, and time-space) realizes dynamic allocation and real-time update of permissions through data logic and database parsing technology, overcoming the limitation of static configuration in a single dimension in traditional permission management. It is capable of quickly adapting to permission requirements in complex organizational structures and multi-business scenarios, improving the adaptability of the system to diverse access control requirements, while reducing the manual maintenance cost of permission management.
3. In the present invention, a multimodal credential system is adopted, combining biometric data (face, iris, voiceprint, finger vein) with behavioral data. An ePASS-ID is generated through the national cryptographic algorithm or other encryption algorithms, and the national cryptographic algorithm or other encryption algorithms are utilized to respectively realize asymmetric encrypted transmission, symmetric encrypted storage, and integrity verification. Compared with traditional single encryption methods, this technical solution significantly improves the anti-theft and anti-tampering capabilities of service data through multi-level encryption and verification mechanisms, especially ensuring the security of the full data lifecycle in cross-network transmission and distributed storage environments.
4. In the present invention, by generating a unique identity identifier for an AI entity and combining it with behavior sandbox isolation technology, real-time monitoring of AI operations and rapid localization of abnormal behaviors are realized. Compared with undifferentiated management access control methods in the prior art, this technical solution can record the model fingerprint and API call logs of the AI entity, facilitating subsequent audit and responsibility tracing, thereby improving the management efficiency and security of the system in scenarios where AI is widely applied.

### BRIEF DESCRIPTION OF THE DRAWINGS

FIG. 1 is a method flowchart of a data security protection method based on anti-AI infiltration technology proposed by the present invention;

FIG. 2 is a system architecture diagram of a data security protection system based on anti-AI infiltration technology proposed by the present invention.

### DETAILED DESCRIPTION

The technical solutions in the embodiments of the present invention will be clearly and completely described below with reference to the accompanying drawings. Obviously, the described embodiments are only a part of the embodiments of the present invention, rather than all the embodiments. Based on the embodiments of the present invention, all other embodiments obtained by a person of ordinary skill in the art without creative efforts shall fall within the protection scope of the present invention.

### Embodiment 1

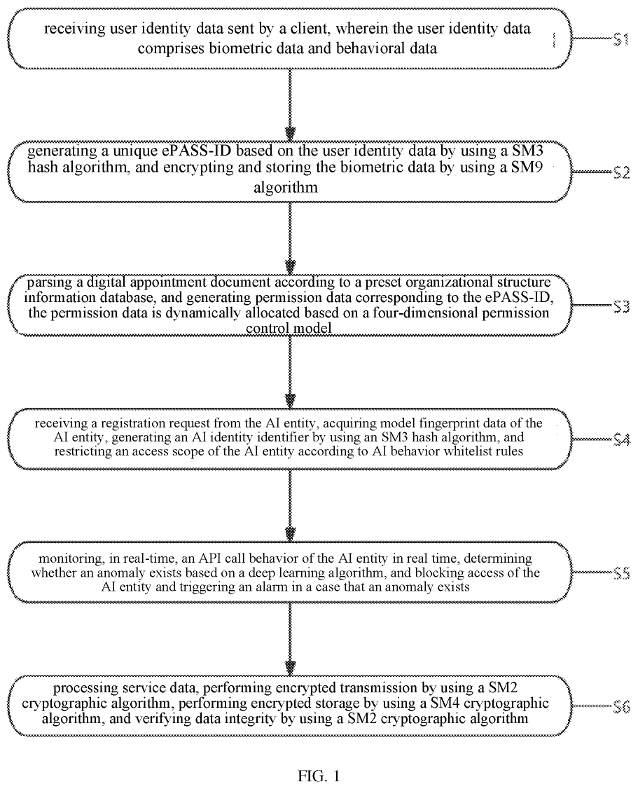

Referring to FIG. 1, in a first embodiment of the present invention, the present invention provides a data security protection method based on anti-AI infiltration technology, applied to a server and comprising steps of:
S1, receiving user identity data sent by a client, wherein the user identity data comprises biometric data and behavioral data;
S2, generating a unique ePASS-ID based on the user identity data by using a national cryptographic algorithm or other encryption algorithms, and encrypting and storing the biometric data by using the national cryptographic algorithm or other encryption algorithms;
S3, parsing a digital appointment document according to a preset organizational structure information database, and generating permission data corresponding to the ePASS-ID, wherein the permission data is dynamically allocated based on a four-dimensional permission control model;
S4, receiving a registration request from an AI entity, performing pre-verification on an identity of the AI entity, acquiring model fingerprint data of the AI entity after the pre-verification is passed, generating an AI identity identifier by using the national cryptographic algorithm or other encryption algorithms, and restricting an access scope of the AI entity according to AI behavior whitelist rules;
S5, monitoring, in real-time, an API call behavior of the AI entity, determining whether an anomaly exists based on a deep learning algorithm, and blocking access of the AI entity and triggering an alarm in a case that an anomaly exists; and
S6, processing service data, performing encrypted transmission by using the national cryptographic algorithm or other encryption algorithms, performing encrypted storage by using the national cryptographic algorithm or other encryption algorithms, and verifying data integrity by using the national cryptographic algorithm or other encryption algorithms.

Specifically, in practical applications, the server may be a high-performance computing device deployed on an enterprise private cloud or public cloud, such as a server cluster supporting multi-core CPUs and GPU acceleration, and its operating system may be Linux or Windows Server to meet high concurrency data processing requirements. In step S1, the user identity data sent by the client is transmitted in JSON format via the HTTPS protocol. The biometric data (e.g., iris images) is uploaded after preprocessing (e.g., grayscale conversion and feature point extraction), and the behavioral data collects dynamic information such as the user's keyboard input frequency and mouse movement trajectory through a client-side log collection module. In step S2, the national cryptographic algorithm is used to generate the ePASS-ID. A hash algorithm conforming to national cryptographic standards is adopted to generate a unique identifier of fixed length, ensuring collision resistance. The national cryptographic algorithm also includes identity-based encryption technology. A key generation center (KGC) is used to distribute a key to each user, and the encrypted biometric data is stored in a distributed database (e.g., MongoDB) to improve query efficiency. The organizational structure information database in step S3 may be an enterprise employee information table built on a relational database (e.g., MySQL). The digital appointment document is stored in XML format, containing fields such as position, department, and permission level. The four-dimensional permission control model implements dynamic allocation logic through a scripting language (e.g., Python), supporting real-time update and revocation of permissions. In step S4, the AI entity registration request is submitted through a dedicated API interface. The request data includes meta-information of the AI entity (e.g., model type, deployment environment) and a digital signature, with the signature generated using the RSA algorithm (2048-bit key). The server verifies the validity of the digital signature through a preset trust anchor certificate, allowing only registration requests from trusted sources (e.g., internal enterprise AI services) to pass. If the verification fails, the system records the request IP and adds it to a temporary blacklist to prevent subsequent attempts. After the verification is passed, the server requires the AI entity to execute standardized test tasks in a controlled environment, wherein the tasks are dynamic challenge sequences comprising 100 predefined API call requests (e.g., GET/api/data, POST/api/update, with input in fixed JSON format {“query”:“test”}) and 15 adversarial challenge requests. The adversarial challenge requests are generated based on historical behavior templates of legitimate AI within the enterprise (extracted from an Elasticsearch database, covering 100,000 calls from 1,000 AI entities). The templates include statistical features of API call sequences (e.g., mean response time, error rate distribution). The challenge requests include non-standard parameters (e.g., malformed JSON {“query”:null}), high-load computation tasks (e.g., matrix operation API), and forged behavior simulation (e.g., abnormally high-frequency calls, 10 calls/second). A legitimate AI can efficiently process these due to optimization (e.g., fine-tuning or caching mechanisms) for enterprise APIs, with an error rate below 5% and stable response time (mean<200 milliseconds); a forged AI exhibits a high error rate (>20%) or inconsistent resource usage (memory fluctuation >30%) due to lack of optimization. The test tasks run in an isolated Docker container (4-core CPU, 8 GB memory, Ubuntu 20.04). Behavior logs are recorded for each call, including response time (milliseconds), memory usage (MB), CPU utilization (%), and API call error rate (proportion of error responses). The behavior analysis algorithm uses a k-means clustering algorithm to extract model fingerprint data. The k-means algorithm is chosen for its efficiency and robustness to high-dimensional data, enabling the extraction of a compact representation of AI computational features from behavior logs. The specific steps are as follows: 1) Normalize the response time, memory usage, CPU utilization, and error rate to map them to [0,1]; 2) Represent each log record as a four-dimensional feature vector, forming a feature matrix of 115 records (100 API calls+15 challenge requests); 3) Apply the k-means algorithm (k=5, determined by the elbow method, initialized with k-means++, maximum 100 iterations, convergence error threshold 0.001) to generate 5 cluster centers; 4) Concatenate the cluster centers into a 20-dimensional vector (5×4 dimensions) as the fingerprint data. The fingerprint data reflects the computational characteristics of the AI (e.g., response time stability, error rate tendency). The fingerprint vector of a legitimate AI forms compact clusters (intra-cluster distance<0.1) due to low error rate and high stability, while a forged AI presents as outliers (inter-cluster distance>0.3) due to high error rate and resource anomalies. To verify the distinguishing capability of the fingerprint, the system calculates the Euclidean distance between the fingerprint vector and the legitimate AI template. The mean distance for a forged AI exceeds 2 standard deviations. The test tasks are repeated 3 times, and the mean fingerprint is taken to ensure consistency; if fewer than 90 logs are recorded, the system rejects the registration and logs the anomaly. The fingerprint data is used to generate a 32-byte AI identity identifier through the national cryptographic algorithm (SHA-256), which is stored in MongoDB. The whitelist rules are based on the functional scope (e.g., “read-only operation”) and the fingerprint data, stored in JSON format, with Redis cache supporting 100,000 queries per second. If the registration fails, the system sends an alarm via SMTP. In step S5, the API call behavior of the AI entity is monitored in real-time, whether an anomaly exists is determined based on a deep learning algorithm, and access of the AI entity is blocked and an alarm is triggered in a case that an anomaly exists. Specifically, the AI behavior sandbox for real-time monitoring is built based on Linux cgroups and namespace technologies. Each AI entity is allocated independent CPU and memory resources (2 cores, 4 GB) to prevent resource contention. A lightweight agent program (written in Go language) runs inside the sandbox to collect API call logs in real time, including call time, interface name, parameters, and error rate (defined from the challenge tasks in step S4). The logs are transmitted to the server via Kafka and stored in Elasticsearch. Anomaly detection uses a Long Short-Term Memory (LSTM) network model, trained with the PyTorch framework, with a training objective of binary classification (normal vs. abnormal). The training samples include: 1) Normal samples: 100,000 historical API calls (over 30 days, from 1,000 AI entities) from legitimate AI within the enterprise. Features include call time, interface name, parameter hash value, and error rate (introduced from S4, <5%), labeled as “normal”. 2) Abnormal samples: 5,500 records generated by red team testing, covering high-frequency probing (1,000 records), unauthorized access (1,000 records), GAN forgery (1,000 records), low-frequency forgery (500 records), and hybrid attacks (1,000 records, e.g., forgery+unauthorized access), with an error rate>20%, labeled as “abnormal”. The samples are stored in Elasticsearch. To adapt to the LSTM, data preprocessing is performed as follows: call time is normalized to [0,1] relative time intervals; interface names are converted to 64-dimensional vectors using Word2Vec (based on 1,000 API interface names, window size 5, 64-dimensional vectors, 50 epochs, corpus from enterprise API documentation); parameter hash values (256-bit SHA-256) are reduced to 32 dimensions using PCA (retaining 90% variance); the error rate is directly used as a 1-dimensional feature; concatenation forms a 97-dimensional feature vector (64+32+1). Combined with a 50-call window, it is mapped to a 128-dimensional input vector through a fully connected layer. Training uses cross-entropy loss, L=−[y·log(ŷ)+(1−y)·log(1−ŷ)], where y is the label (0 for normal, 1 for abnormal). The model is a three-layer LSTM (each layer with 256 hidden units, determined by grid search to balance accuracy and efficiency). The training set to validation set ratio is 8:2, using the Adam optimizer (learning rate 0.001), trained for 100 epochs, achieving an accuracy of 95% and an F1 score of 0.93. The 50-call window is optimized through experimentation, balancing temporal information and computational efficiency. During real-time detection, the system extracts a sequence of 50 calls, converts it into a 128-dimensional vector according to the preprocessing steps, and the LSTM outputs an anomaly probability (threshold 0.7). In a case that an anomaly is detected, access is blocked via iptables, and an alarm is pushed via WebSocket (including anomaly type and timestamp). If fewer than 50 logs are recorded, the sequence is padded with zero vectors or detection is suspended. In a case that an anomaly is detected, a secondary biometric verification (iris or voiceprint, 30-second timeout, permanent ban on failure) is triggered. In step S6, the national cryptographic algorithm and other encryption algorithms are used for asymmetric encryption of data transmission, with key lengths conforming to national standards to ensure transmission security. The national cryptographic algorithm is also used for symmetric encryption, encrypting data blocks before storage in a local encrypted file system (e.g., LUKS). The national cryptographic algorithm verifies data integrity by calculating a check value during data writing and reading to verify consistency and prevent tampering. In step S5, the implementation of anomaly determination based on a deep learning algorithm relies on a pre-trained Long Short-Term Memory (LSTM) network model. The training samples for the model come from the following two types of data:
Normal samples: generated from historical API call logs of legitimate AI entities within the enterprise (e.g., intelligent customer service, data analysis models). The logs include features such as call time, interface name, and parameter hash value. Each record is labeled as “normal”. The sample collection period is 30 days, covering at least 100,000 calls from 1,000 AI entities, and the data is stored in an Elasticsearch database.

Abnormal samples: generated by simulating attack scenarios, including API calls with forged identities (e.g., high-frequency probing, unauthorized access), forged behavioral data (e.g., simulated user mouse trajectories), and known malicious AI behavior patterns (e.g., call sequences based on open-source malicious scripts). The abnormal samples are generated through red team testing, with simulated attacks covering scenarios such as GAN forgery and SQL injection. Each type of abnormal sample contains at least 5,000 records, labeled as “abnormal”.

The training process uses the PyTorch framework. The model input is a vector representation of the API call sequence (dimension 128). Temporal sequence features are extracted through a three-layer LSTM network, and the output is a binary classification result (normal/abnormal). The model training set and validation set are divided in an 8:2 ratio. After training for 100 epochs, the accuracy reaches over 95%. During anomaly determination, the system extracts the API call sequence of the AI entity in real time and compares it with the trained model. In a case that the classification result is abnormal, blocking and alarm mechanisms are triggered.

The biometric data in step S1 comprises face data, iris data, voiceprint data, and finger vein data; the behavioral data comprises user operation habit data; and the user identity data is verified by a multimodal credential system.

Specifically, the collection devices for biometric data may include an iris scanner (e.g., IrisGuard IG-AD100), a voiceprint input microphone (e.g., Shure SM58), and a finger vein recognition device (e.g., Hitachi H1). These devices connect to the client via USB or Bluetooth. The collected data formats are JPEG (iris), WAV (voiceprint), and binary stream (finger vein), respectively. The iris data is processed to extract the iris boundary using Hough transform. The voiceprint data is processed to extract features using Mel-frequency cepstral coefficients (MFCCs). The finger vein data is processed to generate a vascular texture map using infrared imaging technology. The behavioral data collection module runs on the client operating system (e.g., Windows 10 or Android). It captures keyboard input intervals and mouse click coordinates through hook functions (e.g., SetWindowsHookEx of Windows API), generating time-series data. The sampling frequency can be set to 10 times per second. The multimodal credential system combines dual verification of biometric data and behavioral data. First, the biometric data is preliminarily screened using a Support Vector Machine (SVM) algorithm. After a successful match, a Hidden Markov Model (HMM) is used to analyze the consistency of the behavioral data. If both pass, the identity is confirmed as legitimate. The advantage of multimodal verification lies in improving the robustness of identity authentication. For example, when iris recognition fails due to insufficient light, voiceprint and behavioral data can still serve as supplementary evidence.

The four-dimensional permission control model in step S3 comprises:
an organizational structure dimension, for generating a permission inheritance relationship according to an enterprise hierarchical structure;
a data sensitivity dimension, for performing hierarchical encryption on data based on the national cryptographic algorithm or other encryption algorithms;
a business scenario dimension, for isolating different business environments with encrypted sandboxes created by the national cryptographic algorithm or other encryption algorithms; and a time-space dimension, for restricting access permissions based on GPS and IP addresses.

Specifically, the implementation of the four-dimensional permission control model relies on a multi-level permission management system deployed on the server, developed using the Java Spring framework, and supporting RESTful interface calls. The organizational structure dimension stores enterprise hierarchy information in a tree structure. For example, Department A has a subordinate Group B. The permission inheritance relationship is automatically calculated using an SQL query statement (e.g., WITH RECURSIVE) to ensure that child nodes inherit permissions from parent nodes. The business scenario dimension creates independent encrypted sandboxes using Docker container technology, with each sandbox assigned a unique key and IP address. Sandboxes are isolated via virtual networks, for example, using Kubernetes NetworkPolicy to restrict cross-scenario access. The data sensitivity dimension classifies data into three levels: public, internal, and confidential. Hierarchical keys generated by the national cryptographic algorithm are stored in a Hardware Security Module (HSM, e.g., YubiHSM). The encryption process supports batch processing, capable of processing 1,000 records per second. The time-space dimension combines the client's GPS coordinates (accuracy ±10 meters) and IP address (parsed via a GeoIP database). Permission rules are stored in JSON format. Access requests outside the allowed range will be rejected.

The AI behavior whitelist rules in step S4 comprise:
registering the model fingerprint data of the AI entity, and limiting a data interaction scope of the AI entity; and
prohibiting the AI entity from accessing sensitive data exceeding a permission corresponding to the ePASS-ID of the AI entity.

Specifically, the generation process of the AI behavior whitelist rules includes two stages: AI entity registration and rule matching. During registration, the AI entity must submit model fingerprint data. For example, a deep learning model trained with PyTorch can export parameters using torch. save. The server generates a fingerprint hash value using the national cryptographic algorithm as the AI identity identifier. The data interaction scope is defined by a configuration file and stored in the AI permission collection of MongoDB. The matching of whitelist rules uses a Trie tree algorithm to support fast prefix queries. For example, a rule prohibiting access to a sensitive data table (e.g., user information table) can be written as “deny:select:user_*”, capable of handling 100,000 matching requests per second. The implementation of prohibiting access to sensitive data beyond the permission relies on the Access Control List (ACL) of the database, combined with the AI identity identifier for dual verification. In a case that unauthorized behavior is detected, the system logs the event and sends an alarm email to the administrator via the SMTP protocol.

The monitoring in real-time in step S5 comprises:
isolating an operation of the AI entity in an AI behavior sandbox; and
triggering a secondary biometric verification in a case that an abnormal API call is detected.

Specifically, the AI behavior sandbox for real-time monitoring is built based on Linux cgroups and namespace technologies. Each AI entity is allocated independent CPU and memory resources (e.g., 2 cores, 4 GB) to prevent resource contention. A lightweight agent program (written in Go language) runs inside the sandbox to collect API call logs in real time, including call time, interface name, and parameters. The logs are transmitted to the server for analysis via a Kafka message queue. The deep learning model for anomaly detection is based on the PyTorch framework. The training dataset includes normal API call samples (e.g., GET/api/data) and abnormal samples (e.g., high-frequency POST/api/admin), with model accuracy reaching over 95%. In a case that an anomaly is detected, for example, an API call frequency exceeding 100 calls per second, the system blocks the network connection of the AI entity through iptables rules and simultaneously triggers a secondary biometric verification. The secondary verification pushes a notification to the client (based on the WebSocket protocol), requiring the user to resubmit iris or voiceprint data. The verification timeout is 30 seconds. If the verification is not passed, access of the AI entity is permanently banned.

Step S6 further comprises:
adding a hash digital watermark generated by the national cryptographic algorithm or other encryption algorithms to exported data; and
setting up a multi-level approval process for sensitive data operations and storing the approval process on a blockchain for evidence preservation.

Specifically, the digital watermark generated by the national cryptographic algorithm is realized by calculating a hash value for the exported data (e.g., a PDF document). The hash value is then embedded in the file metadata or an invisible area, such as the XMP field of a PDF. The embedding process is completed using an open-source library like PyMuPDF. During watermark verification, the system recalculates the file hash and compares it with the embedded value to ensure the data has not been tampered with. The multi-level approval process is implemented based on a workflow engine (e.g., Activiti). For example, exporting sensitive data requires two levels of approval from a department manager and a security officer. The approval record is hashed to generate a digest and then stored on the blockchain for evidence preservation. The blockchain storage process uses the Hyperledger Fabric blockchain platform. The data is stored in JSON format, with each record occupying approximately 1 KB of storage space. The advantage of blockchain storage lies in providing an immutable audit log, suitable for scenarios with high compliance requirements, such as data management in government agencies. In addition, the multi-level approval process supports dynamic adjustment, for example, automatically increasing the approval level based on data sensitivity, ensuring process flexibility and security.

To achieve protection against forged identities of AI entities, the present embodiment works collaboratively through the following closed-loop mechanisms:
Identity Pre-verification: In step S4, the registration of an AI entity must pass digital signature and behavior log verification to ensure that only legitimate AI enters the system, eliminating the initial risk of forged identities.

Behavioral Feature Monitoring: Step S5 uses a deep learning model to analyze API call sequences, combined with model fingerprint data, to dynamically detect forged behaviors (e.g., simulating the call pattern of a legitimate AI).

Rapid Response Mechanism: After an anomaly is detected, the system blocks access via iptables and triggers a secondary biometric verification to prevent a forged AI from bypassing protection through a temporary identity.

For example, in an enterprise internal deployment scenario, a legitimate AI (e.g., an automatic report generation model) generates a unique identifier through registration, and its API call pattern conforms to the whitelist rules. When an external malicious AI attempts to forge an identity, its call sequence is identified as abnormal by the deep learning model due to the lack of a legitimate behavior pattern. The system completes blocking within 500 milliseconds, and alarm information is sent to the administrator via SMTP.

### Embodiment 2

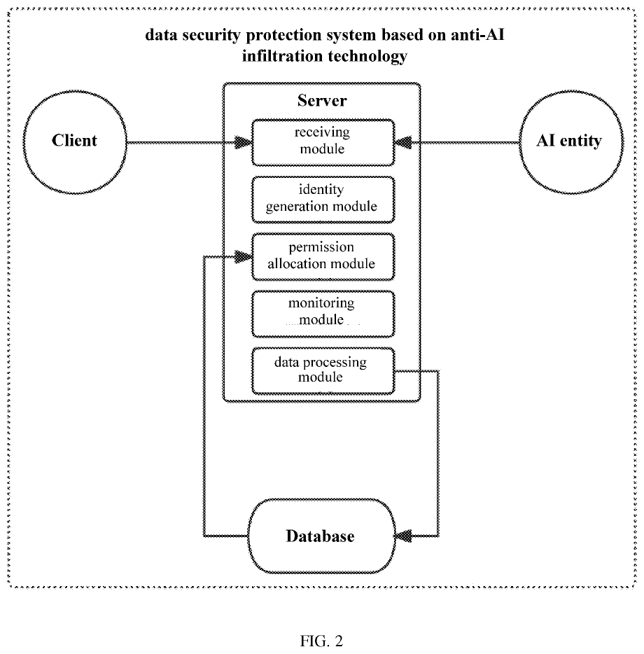

Referring to FIG. 2, in a second embodiment of the present invention, the present invention provides a data security protection system based on anti-AI infiltration technology, configured on a server and comprising:
a receiving module, configured to receive user identity data sent by a client and a registration request from an AI entity;
an identity generation module, configured to generate an ePASS-ID based on the user identity data, and generate an identity identifier for the AI entity;
a permission allocation module, configured to generate and allocate permission data according to an organizational structure information database;
a monitoring module, configured to monitor, in real-time, an API call behavior of the AI entity and determine an anomaly; and
a data processing module, configured to perform encrypted transmission and storage on service data.

Specifically, the data security protection system is deployed on the server, and the physical hardware can be a rack-mounted server supporting a RAID5 disk array, equipped with at least 64 GB of memory and 1 TB SSD storage to meet high concurrency access requirements. The receiving module implements load balancing through Nginx reverse proxy, supporting the processing of 5,000 client requests per second. User identity data and AI registration requests are transmitted in Protobuf format to reduce bandwidth usage. The identity generation module runs in an independent microservice instance (based on Spring Boot), accelerating ePASS-ID generation through Redis cache, capable of generating 10,000 identifiers per second. The generation of the AI identity identifier is coordinated with the AI model fingerprint database (PostgreSQL) to ensure consistency. The permission allocation module synchronizes organizational structure information through a scheduled task (CronJob), updating permission data daily, supporting a scale of 100,000 users. The monitoring module integrates Prometheus and Grafana tools to display API call frequency and anomaly rate in real time. The anomaly determination logic is deployed as an independent Python script, supporting dynamic loading of new rules. The data processing module implements data encryption based on the national cryptographic algorithm and other encryption algorithms, with an encryption speed reaching 50 MB per second. The storage process achieves high availability through a distributed file system (e.g., HDFS).

The identity generation module is configured to generate the ePASS-ID by using the national cryptographic algorithm or other encryption algorithms, and encrypt the biometric data by using the national cryptographic algorithm or other encryption algorithms.

Specifically, the specific implementation of the identity generation module includes an encryption service sub-module running in a Docker container on the server. The container image is built based on Ubuntu 20.04, pre-installed with a national cryptographic algorithm library. The input of the national cryptographic algorithm is a binary stream of the user identity data, for example, an iris feature vector (about 2 KB), and the output is a fixed-length hash value. The generation process takes about 5 milliseconds. The national cryptographic algorithm also includes identity-based encryption technology. The key pair is generated by the KGC, the key length conforms to national standards, and the private key is stored in the HSM to prevent leakage. The encrypted biometric data is saved to the database in Base64 encoding format, supporting fast retrieval. For example, a corresponding record can be queried within 1 millisecond through an index field “user_id”. The module supports multi-threading processing, capable of concurrently processing 1,000 encryption requests per second, suitable for high-load scenarios. In addition, the identity generation module provides an error handling mechanism. For example, in a case that the input data format is incorrect, a JSON-formatted error code is returned to ensure system robustness.

### Embodiment 3

In a third embodiment of the present invention, based on the same inventive concept, the present invention proposes a computer-readable storage medium. The computer-readable storage medium stores a computer program. When executed by a processor, the computer program is configured to implement the steps of the data security protection method based on anti-AI infiltration technology of the above embodiments.

### Embodiment 4

In a fourth embodiment of the present invention, based on the same inventive concept, the present invention proposes a computer device. The terminal comprises: a processor and a memory. The processor and the memory communicate with each other. The memory is used for storing instructions. The processor is used for executing the instructions in the memory to perform the data security protection method based on anti-AI infiltration technology of the above embodiments.

It should be understood that various parts of the present invention can be implemented by hardware, software, firmware, or a combination thereof. In the above embodiments, multiple steps or methods can be implemented by software or firmware stored in a memory and executed by a suitable instruction execution system. For example, if implemented by hardware, as in another embodiment, it can be implemented by any one or a combination of the following technologies known in the art: discrete logic circuits having logic gate circuits for implementing logic functions on data signals, application-specific integrated circuits having suitable combinational logic gate circuits, programmable gate arrays (PGA), field programmable gate arrays (FPGA), etc.

In sum, it should be noted that the above descriptions are only preferred embodiments of the present invention and are not intended to limit the present invention. Although the present invention has been described in detail with reference to the foregoing embodiments, those skilled in the art can still modify the technical solutions described in the foregoing embodiments or equivalently replace some of the technical features therein. Any modifications, equivalent replacements, improvements, etc. made within the spirit and principles of the present invention shall be included in the protection scope of the present invention.

1. A data security protection method based on anti-artificial intelligence (anti-AI) infiltration technology, which is applied to a server and comprises steps of:
S1, receiving user identity data sent by a client, wherein the user identity data comprises biometric data and behavioral data;
S2, generating a unique ePASS-ID based on the user identity data by using a national cryptographic algorithm or other encryption algorithms, and encrypting and storing the biometric data by using the national cryptographic algorithm or the other encryption algorithms;
S3, parsing a digital appointment document according to a preset organizational structure information database, and generating permission data corresponding to the unique ePASS-ID, wherein the permission data is dynamically allocated based on a four-dimensional permission control model;
S4, receiving a registration request from an AI entity, performing pre-verification on an identity of the AI entity, acquiring model fingerprint data of the AI entity after the pre-verification is passed, generating an AI identity identifier by using the national cryptographic algorithm or the other encryption algorithms, and restricting an access scope of the AI entity according to AI behavior whitelist rules;
S5, monitoring, in real-time, an application programming interface (API) call behavior of the AI entity in real time, determining whether an anomaly exists based on a deep learning algorithm, and blocking access of the AI entity and triggering an alarm in a case that the anomaly exists; and
S6, processing service data, performing encrypted transmission by using the national cryptographic algorithm or the other encryption algorithms, performing encrypted storage by using the national cryptographic algorithm or the other encryption algorithms, and verifying data integrity by using the national cryptographic algorithm or the other encryption algorithms.

2. The data security protection method based on anti-AI infiltration technology according to claim 1, wherein, the biometric data in the step S1 comprises face data, iris data, voiceprint data, and finger vein data; the behavioral data comprises user operation habit data; and the user identity data is verified by a multimodal credential system.

3. The data security protection method based on anti-AI infiltration technology according to claim 1, wherein, the four-dimensional permission control model in the step S3 comprises:
an organizational structure dimension, for generating a permission inheritance relationship according to an enterprise hierarchical structure;
a data sensitivity dimension, for performing hierarchical encryption on data based on the national cryptographic algorithm or the other encryption algorithms;
a business scenario dimension, for isolating different business environments with encrypted sandboxes created by the national cryptographic algorithm or the other encryption algorithms; and
a time-space dimension, for restricting access permissions based on global positioning satellite (GPS) and internet protocol (IP) addresses.

4. The data security protection method based on anti-AI infiltration technology according to claim 1, wherein, the AI behavior whitelist rules in the step S4 comprise:
registering the model fingerprint data of the AI entity, and limiting a data interaction scope of the AI entity; and
prohibiting the AI entity from accessing sensitive data exceeding a permission corresponding to the unique ePASS-ID of the AI entity.

5. The data security protection method based on anti-AI infiltration technology according to claim 1, wherein, the monitoring in real-time in the step S5 comprises:
isolating an operation of the AI entity in an AI behavior sandbox; and
triggering a secondary biometric verification in a case that an abnormal API call is detected.

6. The data security protection method based on anti-AI infiltration technology according to claim 1, wherein, the step S6 further comprises:
adding a hash digital watermark generated by the national cryptographic algorithm or the other encryption algorithms to exported data; and
setting up a multi-level approval process for sensitive data operations and storing the multi-level approval process on a blockchain for evidence preservation.

7. A data security protection system based on anti-AI infiltration technology, which is configured on a server for implementing the data security protection method based on anti-AI infiltration technology according to claim 1, and comprises:
a receiving module, configured to receive the user identity data sent by the client and a the registration request from the AI entity;
an identity generation module, configured to generate the unique ePASS-ID based on the user identity data, and generate the AI identity identifier for the AI entity;
a permission allocation module, configured to generate and allocate the permission data according to the preset organizational structure information database;
a monitoring module, configured to monitor, in real-time, the API call behavior of the AI entity and determine the anomaly; and
a data processing module, configured to perform the encrypted transmission and storage on the service data.

8. The data security protection system based on anti-AI infiltration technology according to claim 7, wherein, the identity generation module is configured to generate the unique ePASS-ID by using the national cryptographic algorithm or the other encryption algorithms, and encrypt the biometric data by using the national cryptographic algorithm or the other encryption algorithms.

9. A computer device, comprising: a memory, a processor, and a computer program stored in the memory and executable on the processor, wherein, the processor, when executing the computer program, is configured to implement the data security protection method based on anti-AI infiltration technology according to claim 1.

10. A non-transitory computer-readable storage medium with a computer program stored thereon, wherein, when executed by a processor, the computer program is configured to implement the data security protection method based on anti-AI infiltration technology according to claim 1.
